(19) United States
(12) Patent Application Publication
(10) Pub. No.: US 2011/0155794 A1
(43) Pub. Date: Jun. 30, 2011

(54) METHOD AND DEVICE FOR SHIPPING ITEMS

(76) Inventor: Brian E. Russell, Northfield, IL (US)

(21) Appl. No.: 12/650,199

(22) Filed: Dec. 30, 2009

(51) Int. Cl. B65D 27/00; B65D 27/12; B42D 15/00; B65D 27/06; B65B 1/04; B65B 69/00

(52) U.S. Cl. 229/68.2; 229/77; 283/81; 229/301; 53/467; 53/492

(57) ABSTRACT

A reusable shipping container is provided. The reusable shipping container includes but is not limited to a housing member, a first fastener, and a second fastener. The housing member includes an outer surface opposed to an inner surface. The inner surface is adjacent to and forms a chamber with an opening. The outer surface prevents foreign matter from entering the chamber. The first fastener connected with the housing member at a first side of the opening. The second fastener is connected with the housing member at a second side of the opening. The first fastener is removably connected with the second fastener to form the opening leading into the chamber when the first fastener is not connected with the second fastener.

### FIELD OF THE INVENTION

The present invention relates to a method and device for shipping items. More specifically, it relates to a reusable shipping container for shipping items.

### BACKGROUND

Shipping containers are used to ship items from a first location to a second location. Typically the shipping containers themselves, often envelopes or boxes, are not easily reusable. The containers often having fasteners, such as tape or glue, which can only be used once and typically have to be reapplied in order for the container to be used again for shipping. Having to reapply the fasteners is often not convenient or cost effective. Many times the container is simply destroyed or damaged beyond repair when opened at the second location.

As a result, it would be desirable to have a reusable shipping container with fasteners that do not have to be reapplied each time the container is opened and then sealed again. Additionally, a reusable shipping container may benefit the environment as the container could be reused many times instead of just once.

### SUMMARY

In one aspect, a reusable shipping container is provided. The reusable shipping container includes but is not limited to a housing member, a first fastener, and a second fastener. The housing member includes an outer surface opposed to an inner surface. The inner surface is adjacent to and forms a chamber with an opening. The outer surface prevents foreign matter from entering the chamber. The first fastener connected with the housing member at a first side of the opening. The second fastener is connected with the housing member at a second side of the opening. The first fastener is removably connected with the second fastener to form the opening leading into the chamber when the first fastener is not connected with the second fastener.

In another aspect, a reusable shipping container is provided. The reusable shipping container includes but is not limited to a housing member, a first fastener, and a second fastener. The housing member comprises a flexible, water-resistant fabric, wherein the housing member defines a chamber and an opening leading to the chamber. The first fastener is connected with the housing member at a first side of the opening. The second fastener is connected with the housing member at a second side of the opening. The second side is opposed to the first side. The first fastener is removably connected with the second fastener.

In one aspect, a method for shipping items in a container is provided. The method includes but is not limited to inserting a first item into a chamber defined by the container through an opening leading to the chamber. The method also includes but is not limited to sealing the opening by connecting a first fastener to a second fastener. The first fastener and the second fastener are reconnectable fasteners.

The scope of the present invention is defined solely by the appended claims and is not affected by the statements within this summary.

### BRIEF DESCRIPTION OF THE DRAWINGS

The invention can be better understood with reference to the following drawings and description. The components in the figures are not necessarily to scale, emphasis instead being placed upon illustrating the principles of the invention.

FIG. 1 depicts a front view of a reusable shipping container in accordance with one embodiment of the present invention.

FIG. 2 depicts an enlarged partial, front view of the reusable shipping container of FIG. 1, in accordance with one embodiment of the present invention.

FIG. 3 depicts enlarged partial, front view of the reusable shipping container of FIG. 1, in accordance with one embodiment of the present invention.

FIG. 4 depicts a perspective rear view of the reusable shipping container of FIG. 1 in an open position, in accordance with one embodiment of the present invention.

FIG. 5 depicts a rear view of the reusable shipping container of FIG. 1 in an open position, in accordance with one embodiment of the present invention.

FIG. 6 depicts a flowchart illustration of methods and apparatus (systems), in accordance with one embodiment of the present invention.

### DETAILED DESCRIPTION

By combining reconnectable fasteners with a housing, a reusable shipping container is formed which can be used and reused to ship various items. Preferably, the housing comprises a water-resistant or water-proof fabric which prevents foreign matter from entering the housing and contaminating any item in the housing. In one embodiment, the housing comprises a water-resistant fabric and a zipper is used as the reconnectable fastener and sewn onto the water-resistant fabric. By using a zipper, the reusable container allows for quick and convenient sealing and unsealing of the housing. In one embodiment, the zipper is then locked using a zip-tie and prevented from accidentally opening the housing during the shipping of the container.

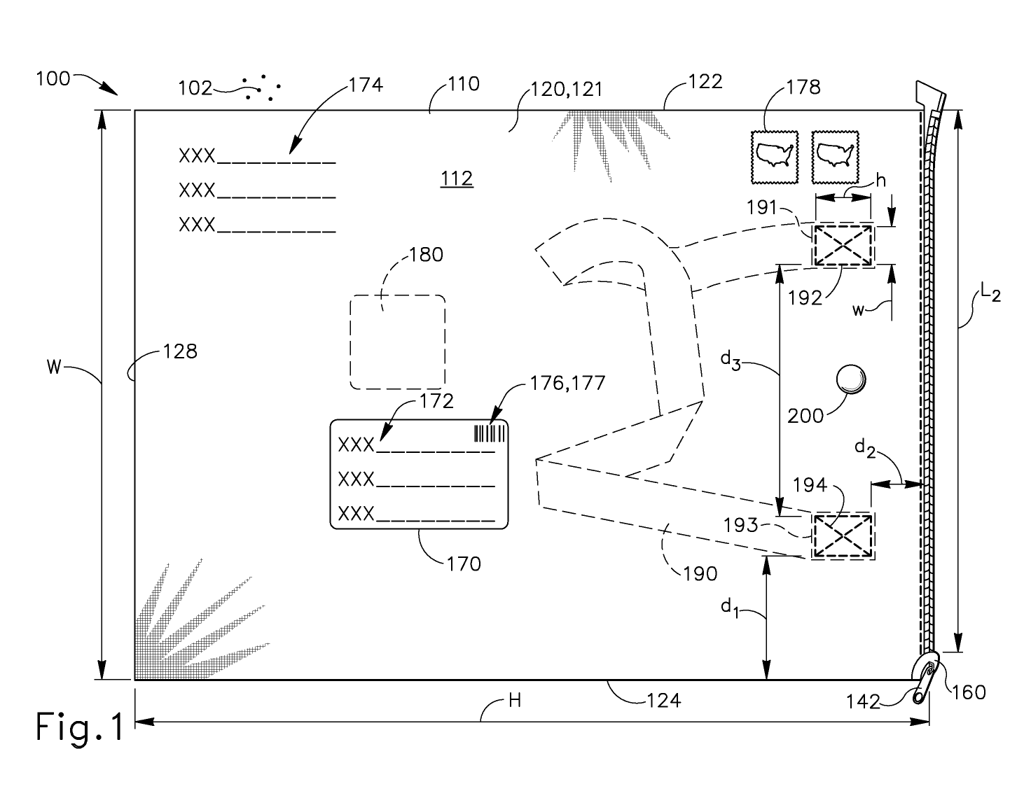

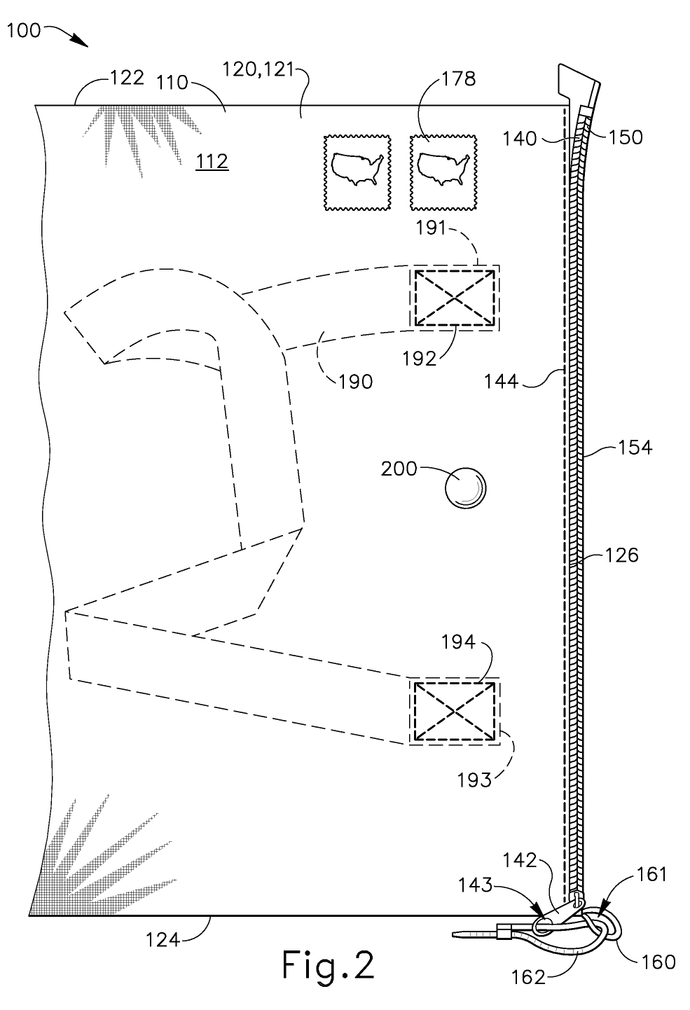

Referring now to FIGS. 1 and 2, there is shown a reusable shipping container 100 for sending an item 180 having a housing member 110 defining a chamber 130, a first fastener 140, and a second fastener 150. The reusable shipping container 100 is any container which can be used and reused to ship item 180 residing within chamber 130 from one location to a second location through a courier service, such as the U.S. Postal Office, FedEX, UPS, etc. The reusable shipping container 100 is preferably a flexible container such as an envelope or a bag, but may include or surround other types of containers such as a box. Item 180 includes any item or good which can be shipped from one location to a second location through a courier service. Item 180 includes such things as papers, letters, magazines, books, clothing, t-shirts, shirts, pants, sweaters, food, electronic goods, house wares, boxes, etc.

Housing member 110 comprises a sheet of material 120, preferably a fabric 121. Using fabric 121 allows for fasteners 140, 150 to be affixed to housing member 110 in a secure manner, such as by being sewn directly onto the housing member 110. In one embodiment, housing member 110 comprises a water-resistant or water-repellent fabric such as Boat Shrunk Canvas (Sunforger), Rip Stop, Nylon, Poly Cotton Canvas, Chair Duck, Sunbrella Canvas, polymer based fabrics, non-woven fabrics, bamboo fabrics, and Poly Foam Spandex. Using a water-resistant fabric allows housing member 110 to be able to resist but not completely prevent foreign matter 102 from entering chamber 130 and contaminating or damaging item 180. By using a water-resistant or water-repellent fabric, foreign matter 102, such as particles of water, is deterred from entering the chamber 130. However, over time, some foreign matter 102 may enter chamber 130. Foreign matter 102 includes any particle of matter larger than 10 microns in diameter, and more preferably larger than 1 micron in diameter, and more preferably larger than 0.1 microns in diameter, and most preferably larger than 0.1 nanometers in diameter.

In one embodiment, housing member 110 comprises a water-proof fabric such as Seamark Marine Fabric, Stamoid Marine Fabric, eVent by eVent fabrics, Nikwax Directional Textiles by Paramo Directional Clothing Systems, Fur Technology by FurTech, Gore-Tex, Sympatex, 3-ply Entrant-EVmembrane by Mountain Equipment Co-op, AquaNix by Taiga Works, Entrant by Toray Industries, Dermizax by Toray Industries, Drilite Extreme by Mountain Equipment, HyVent made for The North Face by Toray, H2No made for Patagonia Inc. by Toray, Omni-Tech by Columbia Sportswear, Conduit made by Mountain Hardwear, Triplepoint Ceramic by Lowe Alpine, Precip by Marmot, Watergate by Outdoor Designs, Closely woven cotton, Polymer-encapsulated cotton EPIC made by Nextec, Wax knocked up cotton or cotton/polyester mixes such as those used in Barbour coats and Fjallraven's G-1000 fabric, Epoxy, Hyper-Dri by Mark's Work Wearhouse, Ventile by Ventile, Trilogy by Ripzone, Stormtech by Peter Storm, c change by Schoeller textiles, Texapore by Jack Wolfskin, Water-resistant Cotton by OrganoClick, Ared by Dare2B. Using a water-proof fabric allows housing member 110 to be able to completely prevent foreign matter 102 from entering chamber 130 and contaminating or damaging item 180. By using a water-proof fabric, foreign matter 102, such as particles of water, is completely prevented from entering the chamber 130 and damaging item 180. Additionally, since water-proof fabric is still a fabric 121, items such as fasteners 150 can be sewn onto the housing member 110.

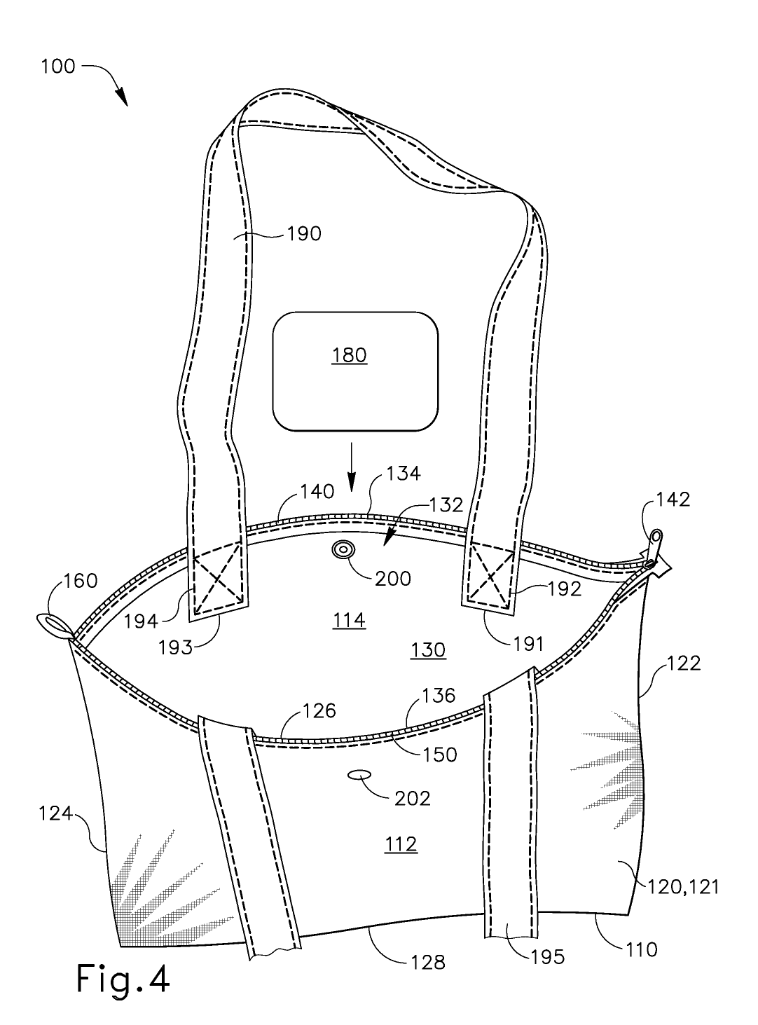

Referring now to FIG. 4, housing member 110 includes an outer surface 112 which surrounds the outside of the housing member 110. The outer surface 112 is opposed to an inner surface 114 which is adjacent to and forms chamber 130 having an opening 132. The outer surface 112 prevents foreign matter 102 from entering the chamber 130 and is preferably formed of fabric 121 and more preferably of a water-resistant, water-repellent, or water-proof fabric. Outer surface 112 includes a first edge 122 opposed to a second edge 124, and a third edge 126 opposed to a fourth edge 128. Preferably three edges, first edge 122, second edge 124, and fourth edge 128 are sealed so as to prevent foreign matter 102 from entering chamber 130. Edges 122, 124, 128 may be sealed by connecting the first sheet of material 120 with a second sheet of material (not shown) along edges 122, 124, 128. Preferably, the first sheet of material 120 and the second sheet of material are sewn together, however they may be glued or welded together. In one embodiment, first sheet of material 120 is folded in half to form fourth edge 128, first edge 122 is connected with first edge 122, and second edge 124 is connected with second edge 124, to form housing member 110 having chamber 130. Third edge 126 is left unsealed to form opening 132. Preferably, the height H of the housing member 110 measured from the third edge 126 to the fourth edge 128 is from one to one hundred centimeters, and more preferably from two to fifty centimeters, and most preferably about 36.83 centimeters, ±10%. Preferably, the width W of the housing member 110 measured from the first edge 122 to the second edge 124 is from one to one hundred centimeters, and more preferably from two to fifty centimeters, and most preferably about 30.48 centimeters, ±10%.

Referring now to FIG. 1, outer surface 112 preferably includes a shipping label 170, a return address 174, and postage 178. The shipping label 170 includes a shipping address 172 which identifies the destination for which the container 100 is to be shipped. Preferably, the shipping label 170 also includes optically scanned code 176, such as a bar code 177, which is machine readable and which also identifies the destination for which the container 100 is to be shipped, and which may identify other items, such as whether the postage has been paid. Postage 178 may be prepaid and included on the shipping label 170, or postage 178 may be purchased and separately attached to the outer surface 112, as shown in FIG. 1.

Referring now to FIGS. 2, 3 and 4, housing member 110 includes first fastener 140 connected with the housing member 110 at a first side 134 of the opening 132 along edge 126. The first fastener 140 is a member which can fasten or connect with another member, preferably another fastener, such as a complimentary fastener. First fastener 140 is preferably a reconnectable fastener which is configured to connect with and then disconnect from a complimentary fastener multiple times. First fastener 140 includes any type of device adapted to connect with and then disconnect from another device, and includes such thing as: mechanical fasteners including hook and loop type fasteners such as laces, strings, cable-ties or zip-ties, VELCRO™, snap-fit arrangements such as snap button fasteners and other snap-fit members, a threaded arrangement such as laces and openings through which the laces are threaded and tied, zippers, and buttons and buttons holes; and magneto-electrical fasteners such as magnets, electrical magnets, and charged couplings.

Housing member 110 also includes second fastener 140 connected with the housing member 110 at a second side 136 of the opening 132 along edge 126. The second fastener 150 is a member which can fasten or connect with another member, preferably another fastener, such as a complimentary fastener. Second fastener 150 is preferably a reconnectable fastener which is configured to connect with and then disconnect from a complimentary fastener multiple times. Second fastener 150 includes any type of device adapted to connect with and then disconnect from another device, and includes such thing as: mechanical fasteners including hook and loop type fasteners such as laces, strings, cable-ties or zip-ties, VELCRO™, snap-fit arrangements such as snap button fasteners and other snap-fit members, a threaded arrangement such as laces and openings through which the laces are threaded and tied, zippers, and buttons and buttons holes; and magneto-electrical fasteners such as magnets, electrical magnets, and charged couplings.

The first fastener 140 is removably connected with the second fastener 150 to form the opening 132 leading into the chamber 130 when the first fastener 140 is not connected with the second fastener 150. Preferably, the first and second fasteners 140, 150 are complimentary fasteners which can connect with each other. More preferably, the first and second fasteners 140, 150 are reconnectable fasteners which can connect with and disconnect from each other multiple times. Preferably, the first fastener 140 can connect with and then disconnect from second fastener 150 more than ten times, and preferably more than 100 times, and more preferably more than 1000 times, and most preferably more than 10,000 times.

Referring now to FIG. 4, in one embodiment, the housing 110 comprises a water-resistant fabric 121 and the reconnectable fasteners 140, 150 comprise a zipper 154 which is fastened onto the water-resistant fabric 121 using fasteners 144, which are preferably stitches. The zipper 154 may also be fastened using other types of fasteners, such as glue. By using a zipper 154, the reusable container 100 allows for quick and convenient sealing and unsealing of the housing 110 and opening 132. Furthermore, the zipper 154 also prevents foreign matter 102 from entering the chamber 130. The zipper 154 includes an opening member 142 which helps to pull apart the zipper 154 and form opening 132 exposing the chamber 130. Preferably, the zipper 154 has a length L_{z} of five to 100 centimeters, and more preferably of 10 to 50 centimeters, and most preferably of about 33 centimeters, ±10%. Preferably, the zipper 154 is a two-way zipper which can be opened and closed.

Referring now to FIG. 4, opening 132 is formed between the first and second fasteners 140,150 when the first fastener 140 is not connected with the second fastener 150.

Preferably, an opening member 142 is used to disconnect first fastener 140 from second fastener 150, as shown in FIG. 4. Preferably, the force required to pull apart and disconnect the first fastener 140 from the second fastener 150, without using opening member 142, is greater than 25 Newtons, and preferably greater than 50 Newtons, and more preferably greater than 75 Newtons, so as to prevent an accidental separation between the first fastener 140 and the second fastener 150.

Referring now to FIGS. 1, 2, and 3, in one embodiment, the reusable shipping container 100 further comprises a retaining member 160 connected with the housing member 110. The retainer member 160 prevents the first fastener 140 from accidentally disconnecting from the second fastener 150. Referring now to FIG. 2, in one embodiment, the reusable shipping container 100 further comprises a fastener 162 connecting the retaining member 160 with the first and second fasteners 140, 150, and preferably, the opening member 142. Preferably, the fastener 162 is looped through an opening 161 formed by the retaining member 160 and a second opening 143 formed by the fasteners 140, 150 and specifically the opening member 142. In this manner, fastener 162 is used to secure and prevents the first fastener 140 from accidentally disconnecting from the second fastener 150 for secure shipping. Fastener 162 includes any type of device adapted to connect with another device, and includes such thing as: mechanical fasteners including hook and loop type fasteners such as laces, strings, zip-ties, VELCRO™, snap-fit arrangements, a frictional arrangement which includes members which frictionally engage each other, screws, nails, nuts and bolts, ball joints and sockets, and hydraulic engagement; chemical fasteners such as epoxy or other types of glue, and solder or other types of welding engagements; magneto-electrical fasteners such as magnets, electrical magnets, and charged couplings. In one embodiment, the fastener 162 is a common zip-tie or cable-tie type fastener preferably made of a sturdy Nylon tape with an integrated gear rack, and on one end a ratchet within a small open case.

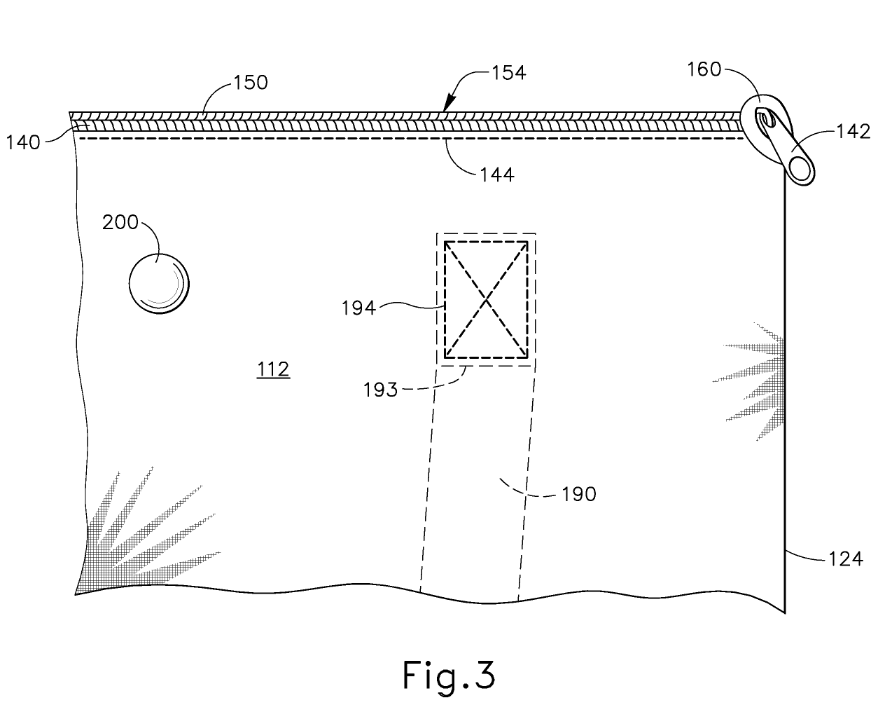

Referring now to FIG. 3, in one embodiment, the retaining member 160 engages the opening member 142, and prevents the opening member 142 from disconnecting first fastener 140 from the second fastener 150. In one embodiment, the retaining member 160 wraps around the opening member 142 to prevents the opening member 142 from moving and disconnecting first fastener 140 from the second fastener 150. Preferably, the retaining member 160 has a length of two to four centimeters, and more preferably of two to three centimeters, and most preferably of about 2.54 centimeters, ±10%.

Referring now to FIGS. 1, 2, 4, and 5, in one embodiment, the housing member 110 includes a first handle 190 located in the chamber 130 attached to the inner surface 114 of the housing member 110 along the first side 134 of opening 132, and a second handle 195 located in the chamber 130 attached to the inner surface 114 of the housing member 110 along a second side 136 of opening 132. The first and second handles 190, 195 are affixed to the housing member 110 with fasteners 192, 194 and fasteners 197, 199, respectively. Preferably, fasteners 192, 194, 197, 199 fixedly connect the handles 190, 195 to the housing member 110, and preferably to inner surface 114 of the housing member 110. Preferably, the fasteners 192, 194, 197, 199 comprise fasteners such as stitches sewn through the sheet of material 120, or glue. Fasteners 192, 194, 197, 199 include any type of device adapted to connect with another device, and includes such thing as: mechanical fasteners including hook and loop type fasteners such as laces, strings, cable-ties or zip-ties, VELCRO™, snap-fit arrangements, a frictional arrangement which includes members which frictionally engage each other, screws, nails, nuts and bolts, ball joints and sockets, and hydraulic engagement; chemical fasteners such as epoxy or other types of glue, and solder or other types of welding engagements; magneto-electrical fasteners such as magnets, electrical magnets, and charged couplings.

Fastener 192 connects a first end 191 of first handle 190 with housing member 110 and fastener 194 connects a second end 193 of first handle 190 with housing member 110. Fastener 197 connects a first end 196 of second handle 195 with housing member 110 and fastener 199 connects a second end 198 of second handle 195 with housing member 110. Preferably, the force required to pull apart and disconnect the first handle 190 or the second handle 195 from the housing member 110, is greater than 50 Newtons, and preferably greater than 100 Newtons, and more preferably greater than 200 Newtons, so as to prevent an accidental separation between the handles 190, 195 and the housing member 110. In one embodiment, the fasteners 192, 194, 197, 199 are stitches which form a cross-pattern, as shown in FIGS. 3, 4, and 5. Preferably the width w and height h of the cross pattern is each from one to ten centimeters, and more preferably from two to five centimeters, and most preferably about 2.54 centimeters, ±10%. Additionally, the distance d₁ from each cross pattern to the closest side edge 122, 124 is preferably from one to ten centimeters, and more preferably from two to eight centimeters, and most preferably about 6.35 centimeters, ±10%. The distance d₂ from each cross pattern to the top edge 126 is preferably from one to ten centimeters, and more preferably from two to three centimeters, and most preferably about 2.54 centimeters, ±10%. The distance d₃ between adjacent cross patterns for the same handle 190, 195 along the inner surface 114 is preferably from one to twenty centimeters, and more preferably from five to fifteen centimeters, and most preferably about 12.7 centimeters, ±10%.

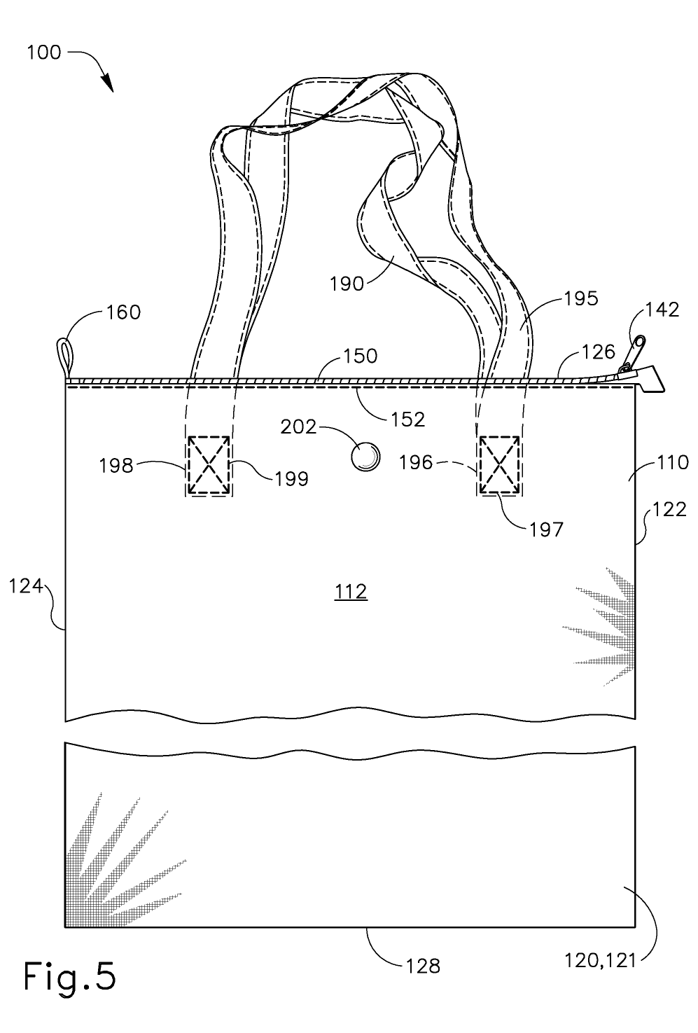

Preferably, the first handle 190 and then second handle 195 are both capable of extending through the opening 132 and outside of the chamber 130, as shown in FIGS. 4 and 5. Extending through opening 132 allows a user to grasp the first and second handles 190, 195 and carry the reusable shipping container 100 conveniently. Preferably, each handle 190, 195 has a length of 30 to 200 centimeters, and more preferably of 50 to 100 centimeters, and most preferably of about 61 centimeters, ±10%. In one embodiment, the housing 110 is turned inside out and the handles 190, 195 are used to carry the housing 110 as a bag.

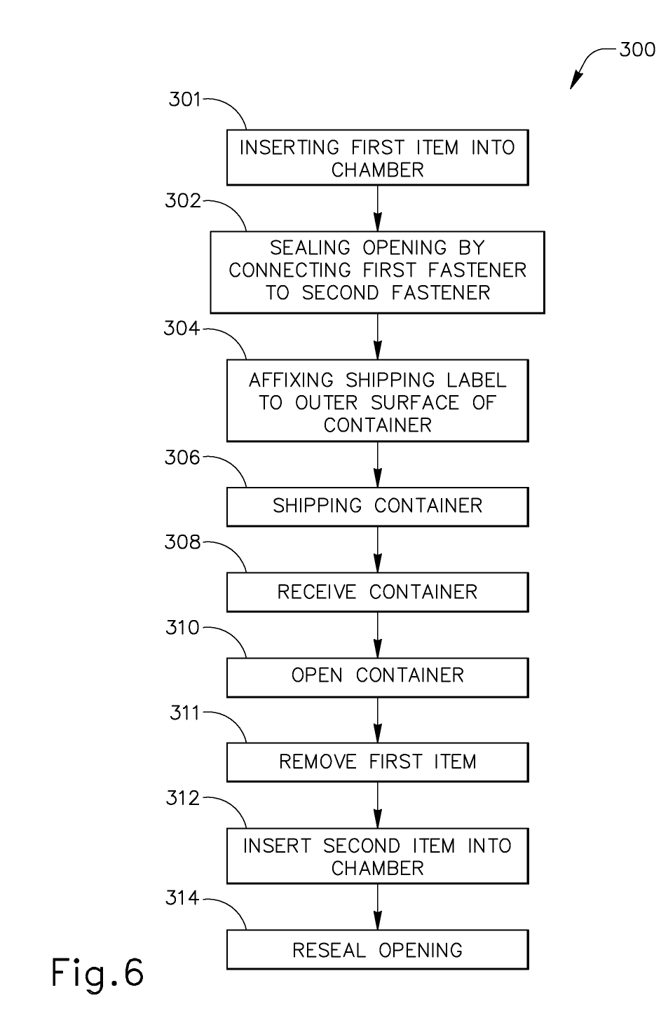

Referring now to FIG. 6, a method 300 for shipping items 180 in reusable shipping container 100 is described. Method 300 begins by first inserting a first item 180 into chamber 130 defined by the container 100 through opening 132 leading to the chamber 130, as described in block 301. Moving to block 302, the opening 132 is then sealed by connecting first fastener 140 to second fastener 150. Preferably, the first fastener 140 and the second fastener 150 are reconnectable fasteners. At block 304, shipping label 170 comprising shipping address 172 is then affixed to outer surface 112 of the container 100. Moving to block 306, the container 100 is then shipped. Preferably, the container 100 is shipped using a courier service. At block 308, the container 100 is received, preferably, by the person or entity at the shipping address 172. Then the opening 132 is unsealed by disconnecting the first fastener 140 from the second fastener 150 and the container 100 is opened, at block 310. The first item 180 is then removed from the container 100 at block 311.

In one embodiment, a second item 180 is inserted into the chamber 130 through the opening 132, as described in block 312. Moving to block 314, the opening 132 is resealed by reconnecting the first fastener 140 to the second fastener 150.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While various embodiments of the invention have been described, it will be apparent to those of ordinary skill in the art that other embodiments and implementations are possible within the scope of the invention. Accordingly, the invention is not to be restricted except in light of the attached claims and their equivalents.

1. A reusable shipping container comprising:
a housing member comprising an outer surface opposed to an inner surface, wherein the inner surface is adjacent to and forms a chamber with an opening, and wherein the outer surface prevents foreign matter from entering the chamber;
a first fastener connected with the housing member at a first side of the opening; and
a second fastener connected with the housing member at a second side of the opening, wherein the first fastener is removably connected with the second fastener to form the opening leading into the chamber when the first fastener is not connected with the second fastener.

2. The reusable shipping container of claim 1, wherein the outer surface has a first edge, wherein the first edge is sealed to prevent foreign matter from entering the chamber.

3. The reusable shipping container of claim 1, wherein the housing member includes a first handle located in the chamber attached to the inner surface of the housing member, wherein the first handle is capable of extending through the opening and outside of the chamber.

4. The reusable shipping container of claim 1, wherein the housing member is a water-resistant fabric.

5. The reusable shipping container of claim 4 further comprising a retaining member attached to the housing and a fastener connecting the retaining member with the first and second fasteners.

6. The reusable shipping container of claim 1, further comprising a retaining member connected with the housing member, wherein the retainer member prevents the first fastener from disconnecting from the second fastener.

7. The reusable shipping container of claim 1, wherein the opening is formed between the first and second fasteners when the first fastener is not connected with the second fastener.

8. A reusable shipping container comprising:
a housing member comprising a flexible, water-resistant fabric, wherein the housing member defines a chamber and an opening leading to the chamber;
a first fastener connected with the housing member at a first side of the opening; and
a second fastener connected with the housing member at a second side of the opening, wherein the second side is opposed to the first side, and wherein the first fastener is removably connected with the second fastener.

9. The reusable shipping container of claim 8, wherein the first and second fasteners are sewn onto the fabric.

10. The reusable shipping container of claim 9 further comprising a shipping address on an outer surface of the housing member and an item for shipping within the chamber.

11. The reusable shipping container of claim 8, wherein the first and second fasteners are one of a pair of snap-fit fasteners, a zipper, a pair of hook and loop fasteners, a button and button hole, and a lace and channel.

12. The reusable shipping container of claim 8, wherein the fabric has an outer surface opposed to an inner surface, wherein the outer surface is sealed along at least two edges to prevent foreign matter from entering the chamber, and the inner surface is adjacent to and forms the chamber.

13. The reusable shipping container of claim 12, wherein the outer surface is capable of adhering to a shipping label.

14. A method for shipping items in a container, comprising:
inserting a first item into a chamber defined by the container through an opening leading to the chamber; and
sealing the opening by connecting a first fastener to a second fastener, wherein the first fastener and the second fastener are reconnectable fasteners.

15. The method of claim 14, further comprising:
affixing a shipping label comprising a shipping address to an outer surface of the container; and
shipping the container.

16. The method of claim 14, further comprising:
receiving the container; and
unsealing the opening by disconnecting the first fastener from the second fastener.

17. The method of claim 16, further comprising:
inserting a second item into the chamber through the opening; and
resealing the opening by reconnecting the first fastener to the second fastener.

18. The method of claim 14, wherein the container is formed with a water-resistant fabric.

19. The method of claim 18, wherein at least one of the first and second fasteners are sewn onto the fabric.

20. The method of claim 18, wherein the water-resistant fabric comprises a non-woven fabric.
